(19) United States
(12) Patent Application Publication
(10) Pub. No.: US 2013/0255176 A1
(43) Pub. Date: Oct. 3, 2013

(54) IN-SITU FOAM CORE PANEL SYSTEMS AND METHOD OF MANUFACTURE

(71) Applicant: Richard W. Roberts, Tecumseh, MI (US)

(72) Inventor: Richard W. Roberts, Tecumseh, MI (US)

(21) Appl. No.: 13/463,705

(22) Filed: May 3, 2012

Related U.S. Application Data
(60) Provisional application No. 61/616,985, filed on Mar. 28, 2012.

(51) Int. Cl. B32B 5/20; B62D 25/20; B60R 13/02; E04B 1/84; A47B 77/02; E01F 13/02; E04G 5/08; E04C 1/40; A47B 13/08

(52) U.S. Cl. CPC B32B 5/20; E04C 1/40; B62D 25/20; B60R 13/0237; A47B 13/08; A47B 77/022; E01F 13/02; E04G 5/08; E04B 1/8409
USPC 52/582.1; 296/191; 108/161; 256/13.1; 182/222; 428/317.5; 181/290

(57) ABSTRACT

A panel system is recited that includes a first panel having a periphery. The panel includes a first plastic layer having a periphery and a second plastic layer opposed and spaced apart from the first layer. The second layer also has a periphery. The first and second layers define a first cavity therebetween. A first in-situ foam core is disposed in the cavity and has a thermal bond to the first and second plastic layers. The panel is capable of supporting 0.1 to 0.5 lbf/in².

### CROSS-REFERENCE TO RELATED APPLICATION

This application claims the benefit of U.S. Provisional Application No. 61/616,985 filed Mar. 28, 2012, the disclosure of which is incorporated in its entirety by reference herein.

### TECHNICAL FIELD

The disclosed embodiments relate to an in-situ foam core panel system and method of manufacturing of same.

### BACKGROUND

Panels, especially load-bearing panels are used in many applications. For example, vehicle manufacturers attempt to reduce the weight of the vehicles in order to enhance the fuel economy of the vehicle. Often, the reduction in weight compromises component part strength as wall thickness of blowmolded, thermoformed, rotocasted, and rotomolded components is reduced in order to a component reduce weight. For example, load floor systems have a relatively long span that is unsupported across the inside of the vehicle, in order to provide load-bearing characteristics. At the same time, plastic processors are consolidating components in load floor systems in order to reduce further the load floor weight and the assembly labor costs. In certain instances, plastic processors have incorporated glass fiber reinforcements into the plastic material used to make load floors. But, these reinforcements and fillings may also render the load floor system component brittle and not suitable for all the characteristics of load floor systems designs. Recently, plastic processors have incorporated cone tack-offs to provide stiffening for vehicle load floor systems in order to compensate for component part strength reduction. But, cone tack-offs produce witness marks that damage aesthetic properties of a show surface. It is desirable to consolidate components in load floor systems while at the same time eliminating cone tack-offs.

### SUMMARY

In at least one embodiment, a panel system includes a first panel having a periphery. The panel includes a first plastic layer having a periphery and a second plastic layer opposed and spaced apart from the first layer. The second layer also has a periphery. The first and second layers define a first cavity therebetween. A first in-situ foam core is disposed in the cavity and has a thermal bond to the first and second plastic layers. The panel is capable of supporting 0.1 to 0.5 lbf/in².

### BRIEF DESCRIPTION OF THE DRAWINGS

FIG. 1 schematically illustrates a vehicle having a load floor system according to at least one embodiment;

FIG. 2 schematically illustrates a fragmentary cross-sectional view of a load floor system component along axis 2-2 of FIG. 1 according to at least one embodiment;

FIG. 3 schematically illustrates a fragmentary cross-sectional view of a load floor system component including a living hinge along axis 3-3 of FIG. 1 according to at least one embodiment;

FIGS. 4A-D schematically illustrate fragmentary cross-sectional views of a method of manufacture of a load floor system component including a living hinge according to at least one embodiment;

FIG. 5 schematically illustrates an isometric view of a vertical panel according to at least one embodiment;

FIGS. 6A-6B schematically illustrate isometric views of panels according to another embodiment;

FIGS. 7A-7B schematically illustrate isometric views of panels according to another embodiment;

FIGS. 8A-8C schematically illustrate isometric views of panels according to yet another embodiment; and

FIGS. 9A-9D schematically illustrate isometric views of panels according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except where expressly indicated, all numerical quantities in the description and claims, indicated amounts of material or conditions of reaction and/or use are to be understood as modified by the word “about” in describing the broadest scope of the present invention. Practice within the numerical limits stated should be desired and independently embodied. Ranges of numerical limits may be independently selected from data provided in the tables and description. The description of the group or class of materials as suitable for the purpose in connection with the present invention implies that the mixtures of any two or more of the members of the group or classes are suitable. The description of constituents in chemical terms refers to the constituents at the time of addition to any combination specified in the description and does not necessarily preclude chemical interaction among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same techniques previously or later referenced for the same property. Also, unless expressly stated to the contrary, percentage, “parts of,” and ratio values are by weight, and the term “polymer” includes “oligomer,” “co-polymer,” “terpolymer,” “pre-polymer,” and the like.

It is also to be understood that the invention is not limited to specific embodiments and methods described below, as specific composite components and/or conditions to make, of course, vary. Furthermore, the terminology used herein is used only for the purpose of describing particular embodiments of the present invention and is not intended to be limiting in any way.

It must also be noted that, as used in the specification and the pending claims, the singular form “a,” “an,” and “the,” comprise plural reference unless the context clearly indicates otherwise. For example, the reference to a component in the singular is intended to comprise a plurality of components.

Throughout this application, where publications are referenced, the disclosure of these publications in their entirety are hereby incorporated by reference into this application to more fully describe the state-of-art to which the invention pertains.

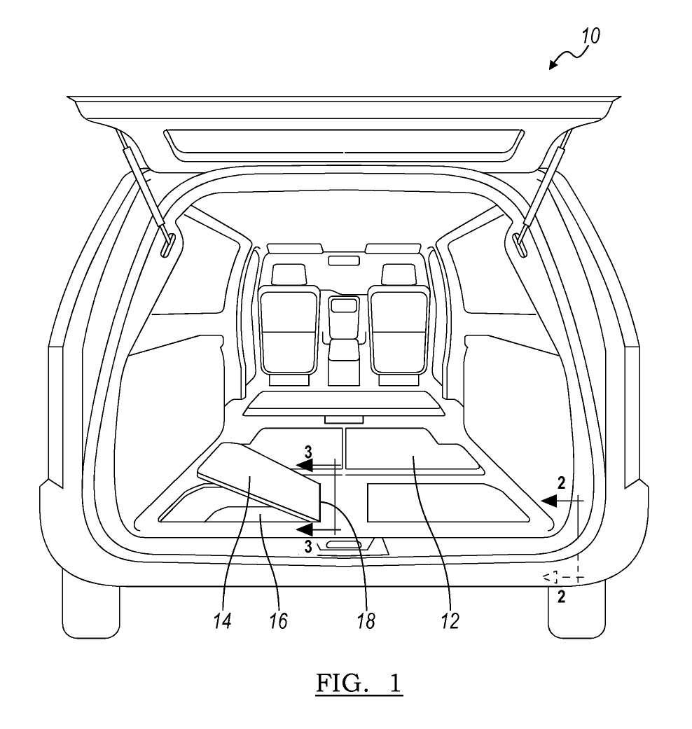

FIG. 1 schematically illustrates a vehicle 10 having a load floor system according to at least one embodiment. Vehicle 10 has a load floor 12 including a load floor door 14 covering a compartment 16 situated beneath load floor 12. Load floor door 14 is hingedly attached to load floor 12 with a living hinge 18.

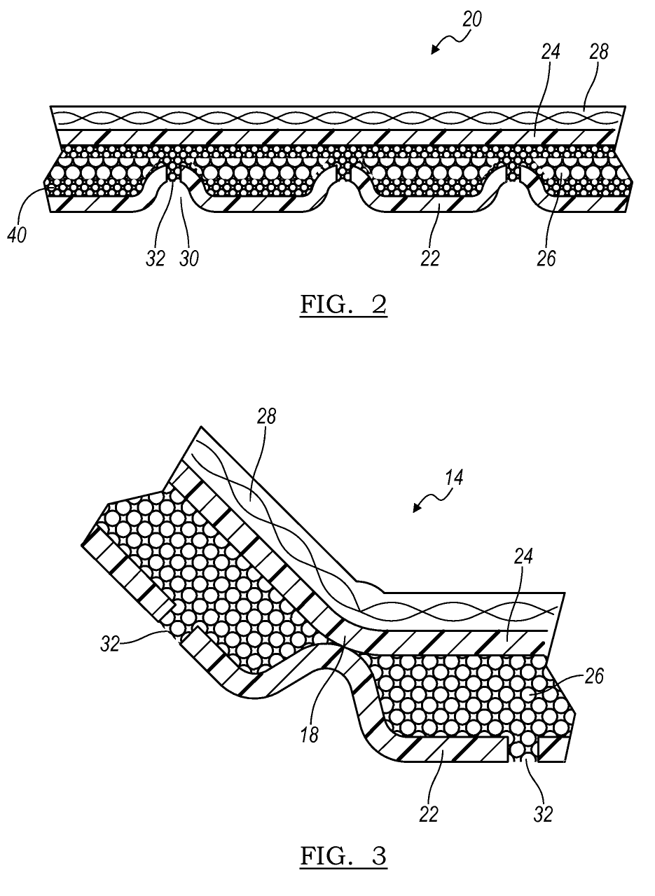

FIG. 2 schematically illustrates a fragmentary cross-sectional view of a load floor system component along axis 2-2 of FIG. 1 according to at least one embodiment. The cross-sectional view is of panel 20 of load floor 12. Panel 20 includes a first layer 22, a second layer 24 opposed to and spaced apart from first layer 22, and an in-situ foam core 26 disposed therebetween and thermally bonded to a first surface of both the first and second layers 22 and 24, respectively. An aesthetic layer 28, such as a carpet or a backed carpet, is connected to second layer 24 on a second surface opposite from in-situ foam core 26.

First layer 22 and includes a plurality of optional embossments 30. In at least one embodiment, a portion of embossments 30 closest to second layer 24 is separated from second layer 24 by a distance ranging from 0.5 inches to 4 inches. In at least one embodiment, a portion of embossments 30 closest to second layer 24 is separated from second layer 24 by a distance ranging from 1 inch to 4 inch. Such distances permit the free flow of pre-expanded beads into the narrowest gaps between first layer 22 second layer 24 in order to uniformly fill core 26 when the pre-expanded beads are expanded to fully-expanded beads 40 in an expansion step. In at least one embodiment, embossments 30 includes an injection port 32 into which a rotary cutter, a bead dispensing device, and a steam pin can be sequentially inserted when creating in-situ foam core 26.

The steps of expanding the pre-expanded beads 20 are illustrated by U.S. patent application Nos. 13/358181, 13/005190, and 12/913132 all of which are incorporated herein by reference.

In at least one embodiment, first and/or second layer 22 and 24, respectively, thickness may range from 0.02 inches to 0.5 inches. In another embodiment, the thickness of first and/or second layer 22 and 24, respectively, may range from 0.125 inches to 0.25 inches.

In at least one embodiment, in-situ foam core 26 thickness may range from 0.15 inches to 6 inches. In another embodiment, in-situ foam core 26 thickness may range from 0.2 inches to 4 inches. In another embodiment, in-situ foam core 26 thickness may range from 0.5 inches to 1 inch.

First and/or second layer 22 and 24, respectively, in at least one embodiment, are formed of a composition of any moldable composition. Non-limiting examples of the composition include, but is not limited to, a liquid silicone rubber, a synthetic rubber, a natural rubber, a liquid crystal polymer, a synthetic polymer resin, and a natural polymer resin. In another embodiment, first and/or second layer 22 and 24, respectively, are formed of a composition of a thermoplastic polymer, a thermoset polymer, or blends thereof having a viscosity ranging from 0.1 grams/10 min to 40 grams/10 min. The viscosity is measured according to ASTM D-1238 at 190° C. with a 2.16 kg weight. In yet another embodiment, first and/or second layer 22 and 24, respectively, are formed of a composition of a polyolefin including polypropylene and polyethylene having a viscosity ranging from 1 grams/10 min to 30 grams/10 min.

In-situ foam core 26, in at least one embodiment, is formed of a composition of any fluid-expandable material. Examples of fluid-expandable material include, but are not limited to, a polyolefin polymer composition, a biopolymer expandable bead, an alkenyl aromatic polymer or copolymer, a vinyl aromatic polymer resin composition, and a polystyrene polymer composition. In at least one embodiment, the polyolefin polymer composition includes polyolefin homopolymers, such as low-density, medium-density, and high-density polyethylenes, isotactic polypropylene, and polybutylene-1, and copolymers of ethylene or polypropylene with other: polymerized bull monomers such as ethylene-propylene copolymer, and ethylene-vinyl acetate copolymer, and ethylene-acrylic acid copolymer, and ethylene-ethyl acrylate copolymer, and ethylene-vinyl chloride copolymer. These polyolefin resins may be used alone or in combination. Preferably, expanded polyethylene (EPE) particles, cross-linked expanded polyethylene (xEPE) particles, polyphenyloxide (PPO) particles, biomaterial particles, such as polylactic acid (PLA), and polystyrene particles are used. In at least one embodiment, the polyolefin polymer is a homopolymer providing increased strength relative to a copolymer. It is also understood that some of the particles may be unexpanded, also known as pre-puff, partially and/or wholly pre-expanded without exceeding the scope or spirit of the contemplated embodiments.

Pre-expanded beads, in at least one embodiment, are the resultant bead after raw bead has undergone a first expansion step of a two-step expansion process for beads. During the first expansion step, raw bead is expanded to 3% to 95% of the fully expanded bead size. The fully expanded bead is the bead that forms in-situ foam core 26. In another embodiment, pre-expanded bead is result of the first expansion step where raw bead is expanded from 25% to 19% of the fully-expanded bead 40 size.

A fluid for the second expansion step of the two-step expansion process for beads causes the pre-expanded beads to expand completely to form the fully expanded beads. Examples of the fluid include, but is not limited to, steam and superheated steam.

Polyolefin beads and methods of manufacture of pre-expanded polyolefin beads suitable for making the illustrated embodiments are described in Japanese patents JP60090744, JP59210954, JP59155443, JP58213028, and U.S. Pat. No. 4,840,973 all of which are incorporated herein by reference. Non-limiting examples of expanded polyolefins are ARPLANK® and ARPRO® available from JSP, Inc. (Madison Heights, Mich.). The expanded polypropylene, such as the JSP ARPROTM EPP, has no external wall such as first and/or second layers 22 and 24, respectively.

In at least one embodiment, in-situ foam core 26 density, after expansion by steam such a such as in FIG. 2, ranges from 1 lb/ft³ to 25 lbs/ft³. In at least one embodiment, in-situ foam core 26 density, after expansion by steam such as in FIG. 1, ranges from 1.5 lbs/ft³ to 15 lbs/ft³. In at least one embodiment, in-situ foam core 26 density, after expansion by steam such as in FIG. 2, ranges from 2 lbs/ft³ to 9 lbs/ft³. In at least one embodiment, in-situ foam core 26 density, after expansion by steam such as in FIG. 1, ranges from 3 lbs/ft³ to 6 lbs/ft³.

Preferably, in at least one embodiment, steam-injected expanded polypropylene (EPP) has a density ranging from 1 lb/ft³ to 20 lbs/ft³. In yet another embodiment, steam-injected EPP may have a density ranging from 1.5 lbs/ft³ to 10 lbs/ft³. In yet another embodiment, steam-injected EPP may have a density ranging from 2 lbs/ft³ to 6 lbs/ft³. In yet another embodiment, steam-injected EPP may have a density ranging from 3 lbs/ft³ to 5 lbs/ft³.

In at least one embodiment, first and/or second layer 22 and 24, respectively, with a range of 0.025 inch thickness to 0.1 inch thickness is comprised of a metallocene polypropylene. Such a combination is found to improve adhesion between first and/or second layer 22 and 24, respectively, and in-situ foam core 26 formed of EPP.

In at least one embodiment, aesthetic layer 28 includes a textile layer such as a carpet layer. In another embodiment, aesthetic layer 28 includes a laminate layer. Non-limiting examples of the laminate layer include a hard wood floor layer, a composite laminate over a core, a resin layer, and a polyurethane coating, such as a truck bed liner.

FIG. 3 schematically illustrates a fragmentary cross-sectional view of a load floor system component, load floor door 14 including living hinge 18 along axis 3-3 of FIG. 1 according to at least one embodiment. First layer 22 connects with second layer 24 to form living hinge 18. Second layer 24 does not need to be a load-bearing component that is structurally rigid. It is preferable that the second layer 24 is flexible, and even more preferably stretchable along two axes, that is, biaxially oriented, such that the second layer 24 is durable for at least 1000 cycles of 180° bending. It is more preferable, the in at least one embodiment, second layer 24 is sufficiently flexible that second layer 24 is durable for at least 5000-10,000 cycles of 180° bending. Surprisingly, is preferable to use the same metallocene polypropylene which gives very good adhesion to in-situ foam core 26 formed of EPP also provides sufficient durability for second layer 24 to meet or exceed the requirements of 180° bending of certain embodiments.

In at least one embodiment, port 32 is not associated with any embossments of first layer 24, such as the embossment forming living hinge 18.

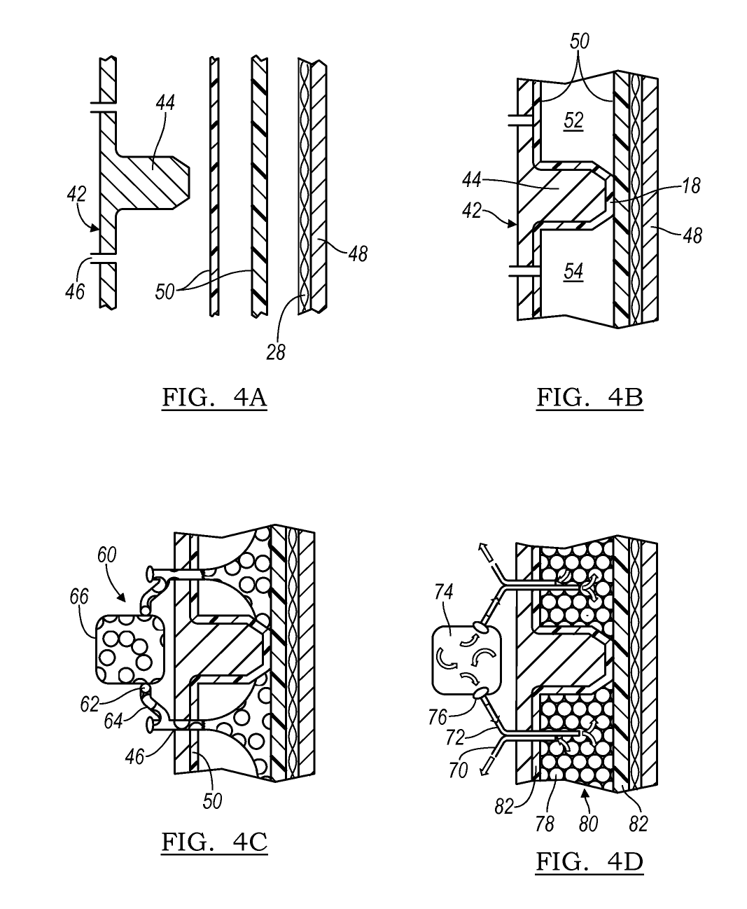

FIGS. 4A-D schematically illustrate fragmentary cross-sectional views of a method of manufacture of load floor door 14 including living hinge 18 according to at least one embodiment. In a blowmolding method of manufacture of load floor door 14, a mold with a first mold portion 42 having a protrusion 44 suitable for forming an embossment and having a port 46 is schematically illustrated in FIG. 4A . Spaced apart and opposed to first mold portion 42 is second mold portion 48. When in an open condition, first mold portion 42 and second mold portion 48 are sufficiently spaced to allow a parison 50 of a polymer composition to pass between the two mold portions 42 and 48. Temporarily attached to second mold portion 48 and disposed between second mold portion 48 and parison 50 is aesthetic layer 28.

In FIG. 4B, first mold portion 42 and a second mold portion 48 have close together to be in contact with parison 50. Protrusion 44 pushes a protion of parison 50 into contact with the other side of parison 50 forming living hinge 18. Living hinge 18 divides parison 50 forming two cavities 52 and 54.

In FIG. 4C, a combination dispensing unit and rotary cutter 60 enter port 46 and cut a hole in parison 50. Valve 62 opens and allows pre-expanded beads 64 to enter cavities 52 and 54 from a bead source 66.

In FIG. 4D, combination dispensing unit and rotary cutter 60 withdraws from port 46 and steam pin 68 and steam vent 70 are inserted into port 46. Steam pins 68 are disposed in cavities 52 and 54, while steam vents 70 remain proximate to port 46. Steam 72 from a steam source 74 passes through a valve 76 and is injected into pre-expanded beads 64 through steam pin 68 causing them to expand forming fully expanded beads 78. Residual steam 72 exits through steam vent 70. Fully expanded beads 78 thermally bonded to parison 50 which comprise walls 82 to form an in-situ foam core 80 in cavities 52 and 54 within walls 82. Steam pins 68 and steam vents 70 withdraw from port 46. First mold portion 42 separates from second mold portion 48 releasing load floor 12 having load floor door 14 hingedly attached with living hinge 18.

While FIGS. 4A-D schematically illustrate forming load floor 12 using the blowmolding process including parison 50, it should be understood that the plastic shaping process could include, but is not limited to, a thermoforming process, a rotomolding process, and a rotocasting process. In the thermoforming process, parison 50 represents the first and second plastic layers of twin-sheet thermoforming process. In the rotomolding and rotocasted processes, parison 50 represents the molten plastic that has been coated onto the mold walls by centrifugal force during the rotational movement of the mold.

In at least one embodiment, load floor 12 is capable of supporting 0.1 to 0.5 lbf/in² when in-situ foam core 80 ranges from 1 inch to 4 inches thick and has a density ranging from 1.5 lbs/ft³ to 6 lbs/ft³ and wall 82 ranges from 0.025 inch thickness to 0.1 inch thickness. In another embodiment, load floor 12 is capable of supporting 0.3 to 0.45 lbf/in².

In at least a first aspect, load floor 12 includes load floor door 14 having living hinge 18, walls 82 and in-situ foam core 82 thermally bonded to walls 82. Wall 82 thickness ranges from 0.025 inches to 0.25 inches. In-situ foam core 80 density ranges from 1 lb/ft³ to 5 lbs/ft³. Associated with this first aspect, is capable of supporting 0.1 to 0.5 lbf/in² when in-situ foam core 80 ranges from 1 inch to 4 inches thick and has a density ranging from lbs/ft³ to 6 lbs/ft³ and wall 82 ranges from 0.025 inch thickness to 0.1 inch thickness.

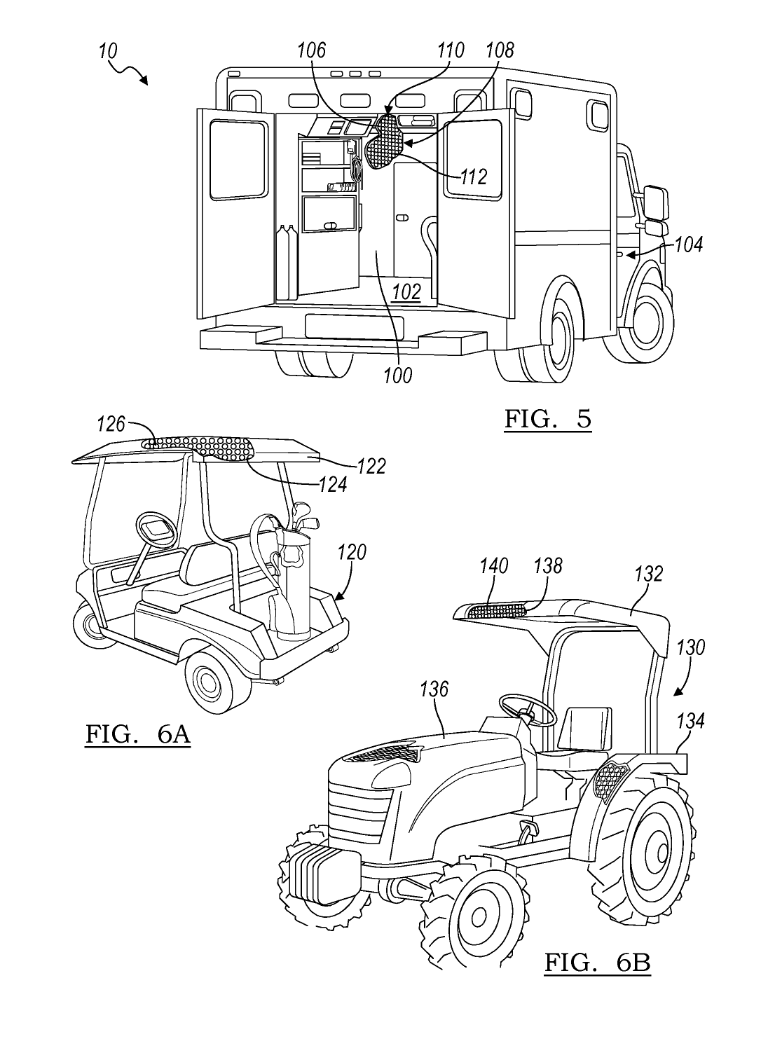

Turning now to FIG. 5, vehicle 10 includes a vertical wall 100 dividing the vehicle back 102 from the front crew cab 104. Non-limiting examples of vehicle 10 include a type II ambulance, as schematically illustrated in FIG. 5, and a commercial delivery vehicle.

Vertical wall 100 includes a first skin 106 and second skin (not visible) 108 which forms a cavity 110 therebetween into which an in-situ foam core 112 has been injected and thermally bonded to skins 106 and 108.

Turning now to FIG. 6A, a golf cart 120 includes a roof 122 having a skin 124 that envelops an in-situ foam core 126.

Turning now to FIG. 6B, a farm tractor 130 has component panels that include a roof 132, fenders 134 and an engine cover 136. Each panel includes a skin 138 which envelops and is thermally bonded to an in-situ foam core 140.

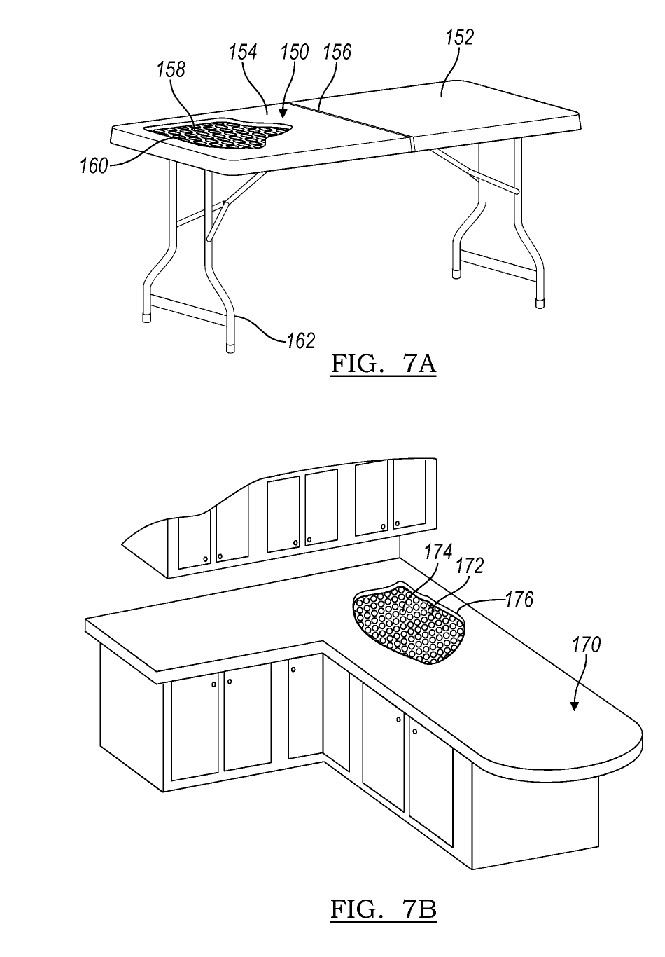

Turning now to FIG. 7A, a folding table 150 is schematically illustrated in at least one embodiment. Folding table 150 has a first panel 152, second panel 154 joined with a living hinge 156. Each panel includes a skin 158 thermally bonded to a in-situ foam core 160. In-situ foam core 160 and sufficient density so as to receive and retain bolts from a leg structure 162 with a bolt pull-out force in excess of 200 lbf/in of thread depth.

Turning now to FIG. 7B, a countertop 170 is schematically illustrated in at least one embodiment. countered top 170 includes a skin 172 thermally bonded to an in-situ molded core 174. Optionally, an aesthetic surface 176 may be bonded to skin 172. Non-limiting examples of aesthetic surface 176 include a laminate layer, a layer of ceramic composition, and a granite surface.

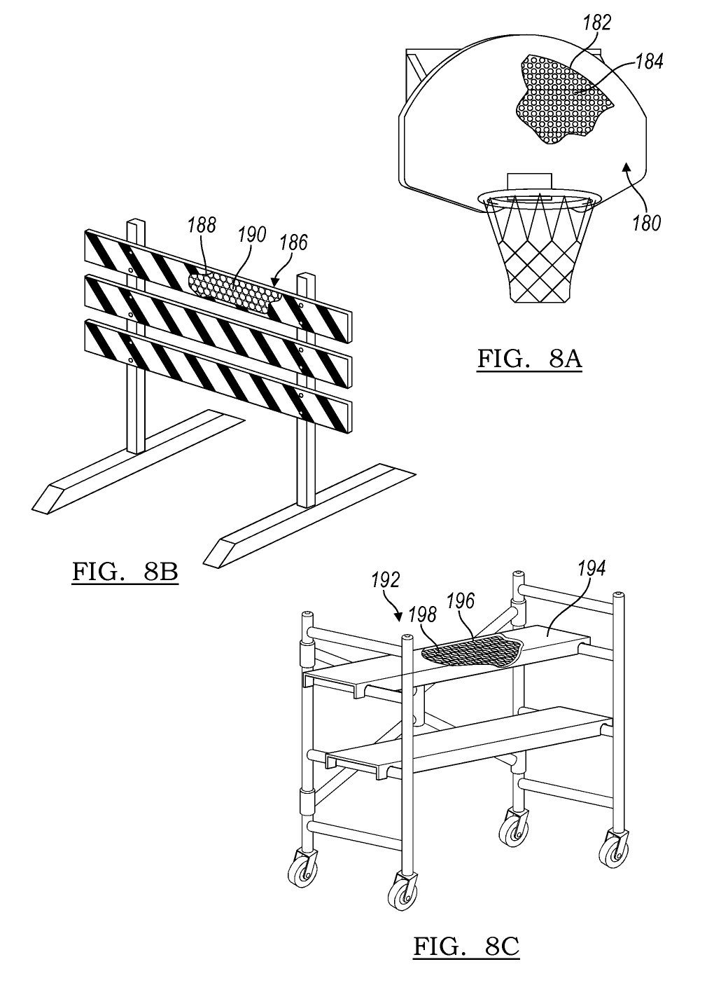

Turning now to FIG. 8A, a basketball backboard 180 is illustrated schematically according to one at least embodiment. Backboard 180 is a skin 182 thermally bonded to an in-situ foam core 184.

Turning now to FIG. 8B, a construction barricade 186 is schematically illustrated according to at least one embodiment. Barricade 186 includes a skin 188 thermally bonded to an in-in situ foam core 190.

Turning now to FIG. 8C, a scaffold 192 is schematically illustrated according to at least one embodiment. Scaffold 192 includes a panel 194 having a skin 196 thermally bonded to an in-situ foam core 198.

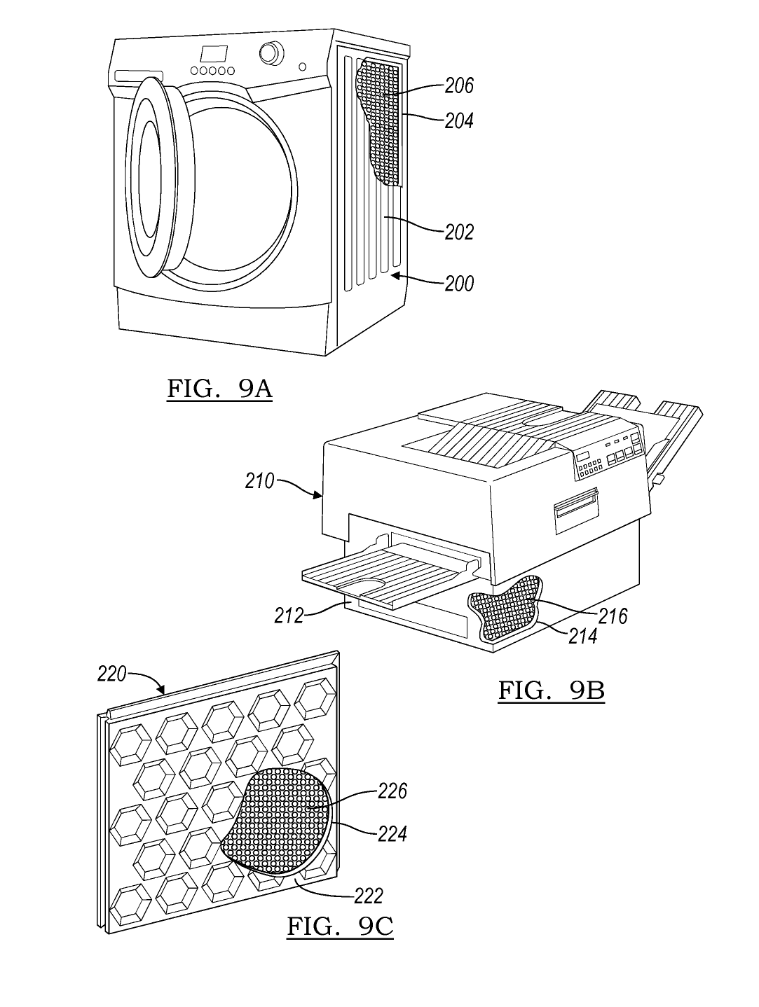

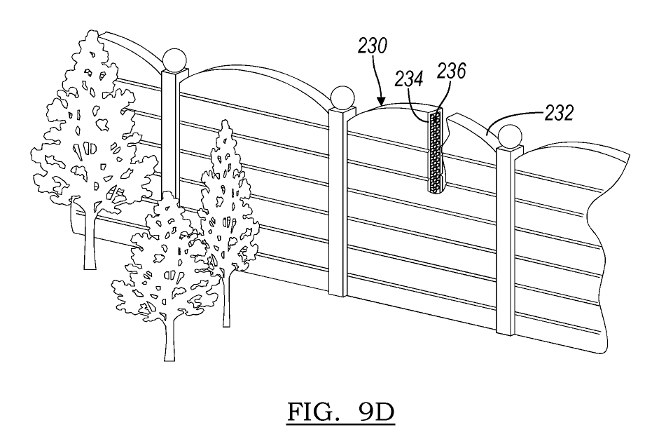

Turning now to FIG. 9A, a household or commercial appliance, such as a washing machine 200, is schematically illustrated according to at least one embodiment. Washing machine 200 includes at least one panel 202 having a skin 204 thermally bonded to an in-situ foam core 206. Having appliances with light weight panels, such as panel 202, is advantageous for installation ease. Appliances with panels such as panel 202 may also be made much quieter by adjusting the density of in-situ foam core 206 to match the sound spectrum of the appliance when operating. Panel 202, in at least one embodiment, has a sound transmission coefficient rating ranging from 25 to 40. In another embodiment, panel 202 as a sound transmission coefficient rating ranging from 30 to 38.

Turning now to FIG. 9B, a copier to 10 includes a kick plate 212 having a skin 214 thermally bonded to an in-situ foam core 216.

Turning now to FIG. 9C, the sound deadening wall panel 220, such as suitable for an anechoic chamber or a concert hall, includes an acoustic panel 222 having a skin 224 thermally bonded to an in-situ foam core 226.

Turning now to FIG. 9D, a roadside sound barrier 230 includes a plurality of panels 232. Each panel has a skin 234 thermally bonded to an in-situ foam core 236. The density of in-situ foam core to 236 can be matched to specific frequencies of sound generated at particular stretches of road depending upon the road surface and the elevation of certain sources of sounds at various frequencies. For example, an asphalt road surface as a different spectrum of frequencies produced when run over by a car tire than does a concrete road surface. Tire-road surface frequencies are generally higher frequency and lower to the ground than frequencies generated by diesel truck exhaust systems and 8 to 10 feet above the ground. In addition, conventional concrete roadside sound barrier panels are 5 to 15 times heavier than the equivalent size roadside sound barrier 230. Roadside sound barrier 230 has the cost advantage of not requiring the use of heavy lifting equipment for installation. Further, roadside sound barrier 230 is not degraded by exposure to chloride from road salt applied to northern US roads during winter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A panel, comprising:
a first plastic layer having a periphery;
a second plastic layer having a region opposed and spaced from the first layer, and a periphery joined to the periphery of the first plastic defining at least one substantially enclosed cavity between the first and second layers; and
a foam core of thermally expandable plastic bead filling the cavity when expanded in situ to create a structural core having a thermal bond with the first and second plastic layers, wherein the panel is capable of supporting 0.1 to 0.5 lbf/in².

2. The panel of claim 1, wherein the first and second plastic layers are joined together along, a hinge axis forming a living hinge dividing the cavity into two cavity regions each filed with a foam core to form two panel sections hinged together.

3. The panel system of claim 1, wherein the panel comprises a vehicle load floor.

4. The panel of claim 2 wherein the first and second plastic layers are formed of a plastic material which is flexible and durable enough to be flexed 180 degrees at least 1000 times.

5. The panel of claim 1, wherein the panel is a component of a vehicle interior.

6. The panel of claim 1, wherein the panel forms an exterior surface of a vehicle.

7. The panel of claim 1, wherein the panel forms a table surface or a counter surface.

8. The panel of claim 1, wherein the panel comprises a basketball backboard.

9. The panel of claim 1, wherein the panel comprises a barricade.

10. The panel of claim 1, wherein the panel comprises a scaffold component.

11. The panel of claim 1, wherein the panel comprises a housing panel or a kick plate.

12. The panel of claim 1, wherein the panel comprises a sound deadening panel.

13. The panel of claim 4, wherein the first and second panels are formed of metallocene polyropylene.

14. A vehicle load floor comprising a panel of claim 4, wherein on of the panel sections forms a hinged door.

15. the vehicle load floor of claim 14 wherein the panel has a thickness between 0.5 and 1.0 inches.

16. The panel of claim 6 forming on of a vehicle roof, engine cover and a fender.

17. The panel of claim 16 wherein the foam core has an expanded density of 2 to 9 lbs/ft³.
